(19) United States
(12) Patent Application Publication
(10) Pub. No.: US 2014/0188653 A1
(43) Pub. Date: Jul. 3, 2014

(54) SELECTION DEVICE, SELECTION METHOD, PROGRAM, AND RECORDING MEDIUM

(71) Applicant: Hiroomi Yamamura, Shinagawa-ku (JP)

(72) Inventor: Hiroomi Yamamura, Shinagawa-ku (JP)

(73) Assignee: RAKUTEN, INC., Shinagawa-ku, Tokyo (JP)

(21) Appl. No.: 14/240,562

(22) PCT Filed: Jun. 27, 2012
(86) PCT No.: PCT/JP2012/066339

§ 371 Date: Feb. 24, 2014

(30) Foreign Application Priority Data
Aug. 26, 2011 (JP) 2011-184604

(51) Int. Cl. G06Q 30/06

(52) U.S. Cl. CPC G06Q 30/0611
USPC 705/26.4

(57) ABSTRACT

A selection device (100) selects a second seller that is allowed to sell a product under a second sales condition after the product for sale by a first seller under a first sales condition becomes sold out. A setter (101) sets an offer deadline. An acceptor (102) accepts an offer of a sales condition of the product containing a number of the products to be sold, a sale price and an introductory text from one or a plurality of sales offerers until the set offer deadline. A selector (103) selects one of the offers based on the sales condition of the accepted offer when the set offer deadline comes, sets the sales offerer with the selected offer as the second seller, and sets the sales condition of the selected offer as the second sales condition. An obtainer (104) obtains a stock quantity of the sales product for sale by the first seller under the first sales condition. A releaser (105) releases an introductory text associated with the second sales condition in order to let the second seller start selling when the obtained stock quantity becomes zero.

### TECHNICAL FIELD

The present invention relates to a selection device, a selection method, a program, and a recording medium, and in particular, to a selection of a seller of a commercial product.

### BACKGROUND ART

Conventionally, shopping systems are known (see, for example, Patent Literature 1) which accept registration of commercial products from multiple sellers, and present Web pages on those commercial products to a user to promote and sell the commercial products. According to such shopping systems, the same commercial product is for sale from multiple sellers. In this case, it is typical that a user compares and checks the WEB pages of the commercial product provided by respective sellers for the same commercial product, and purchases the commercial product that most satisfies the user's desired criteria.

### CITATION LIST

### Patent Literature

Patent Literature 1: Unexamined Japanese Patent Application Kokai Publication No. 2010-152441

### SUMMARY OF INVENTION

### Technical Problem

However, it is bothersome for the user to take time to compare and check from which seller it is better to purchase a given commercial product.

The present invention has been made to address the above-explained technical problem, and it is an objective of the present invention to provide a selection device, a selection method, a program, and a recording medium which are suitable for selecting a seller who offers a commercial product.

### Solution to Problem

A selection device according to a first aspect of the present invention selects a second seller that is allowed to sell a product under a second sales condition after the product for sale by a first seller under a first sales condition becomes sold out, the selection device includes: a setter that sets an offer deadline; an acceptor that accepts an offer of a sales condition for the product containing at least a number of the products to be sold, a sale price and an introductory text from one or a plurality of sales offeres until the set offer deadline; a selector that selects an offer among the offer from the one sales offerer or the offers from the plurality of sales offerers based on the sales condition of the accepted offer when the set offer deadline comes, sets the sales offerer with the selected offer as the second seller, and sets the sales condition of the selected offer as the second sales condition; an obtainer that obtains a stock quantity of the product for sale by the first seller under the first sales condition; and a releaser that releases an introductory text associated with the second sales condition in order to let the second seller start selling when the obtained stock quantity becomes zero.

The aforementioned selection device further includes an estimator that estimates, based on the obtained stock quantity, a sold-out date and time when the product for sale by the first seller under the first sales condition becomes sold out, in which the setter sets a date and time prior to the estimated sold-out date and time as the offer deadline.

In the aforementioned selection device, the setter sets a date and time prior to the estimated sold-out date and time by a predetermined grace period as the offer deadline.

In the aforementioned selection device, the acceptor sets a fewest number of products based on a period until the product becomes sold out after the start of the sale of the product by the first seller, and the number of products to be sold contained in the first sales condition, and the acceptor excludes an offer with the sales condition containing the number of products to be sold that is less than the set fewest number of products.

In the aforementioned selection device, when the product for sale by the first seller under the first sales condition becomes sold out, with the second seller being as a new first seller, an obtainment by the obtainer, an estimation by the estimator, a setting by the setter, and a selection by the selector are executed to repeatedly select a new second seller.

In the aforementioned selection device, the selector selects an offer with a highest score obtained based on the sale price contained in the sales condition, the number of products to be sold contained in the sales condition, and an information quantity of the introductory text contained in the sales condition, and the lower the sale price is, the greater the number of products to be sold is, and the greater the information quantity of the introductory text is, the higher the score is set.

In the aforementioned selection device, the information quantity of the introductory text is defined based on a number of characters, a number of images, or a size of an image, contained in the introductory text.

In the aforementioned selection device, the information quantity of the introductory text associated with an offer among the accepted offers is defined based on a number of words not appearing in the introductory texts associated with the other offers.

A selection method executed by a selection device according to a second aspect of the present invention is for selecting a second seller that is allowed to sell a product under a second sales condition after the product for sale by a first seller under a first sales condition becomes sold out. The selection method includes: a setting step for setting an offer deadline; an accepting step for accepting an offer of a sales condition of the product containing at least a number of the products to be sold, a sale price and an introductory text from one or a plurality of sales offerers until the set offer deadline; a selecting step for selecting an offer among the offer from the one sales offerer or the offers from the plurality of sales offerers based on the sales condition of the accepted offer when the set offer deadline comes, setting the sales offerer with the selected offer as the second seller, and setting the sales condition of the selected offer as the second sales condition; an obtaining step for obtaining a stock quantity of the product for sale by the first seller under the first sales condition; and a releasing step for releasing an introductory text associated with the second sales condition in order to let the second seller start selling when the obtained stock quantity becomes zero.

A program according to a third aspect of the present invention causes a computer to function as a selection device that selects a second seller that is allowed to sell a product under a second sales condition after the product for sale by a first seller under a first sales condition becomes sold out, the program causing the computer to further function as: a setter that sets an offer deadline; an acceptor that accepts an offer of a sales condition of the product containing at least a number of the products to be sold, a sale price and an introductory text from one or a plurality of sales offerers until the set offer deadline; a selector that selects an offer among the offer from the one sales offerer or the offers from the plurality of sales offerers based on the sales condition of the accepted offer when the set offer deadline comes, sets the sales offerer with the selected offer as the second seller, and sets the sales condition of the selected offer as the second sales condition; an obtainer that obtains a stock quantity of the product for sale by the first seller under the first sales condition; and a releaser that releases an introductory text associated with the second sales condition in order to let the second seller start selling when the obtained stock quantity becomes zero.

A computer-readable recording medium according to a fourth aspect of the present invention has stored therein a program that causes a computer to function as a selection device that selects a second seller that is allowed to sell a product under a second sales condition after the product for sale by a first seller under a first sales condition becomes sold out, the program causing the computer to further function as: a setter that sets an offer deadline; an acceptor that accepts an offer of a sales condition of the product containing at least a number of the products to be sold, a sale price and an introductory text from one or a plurality of sales offerers until the set offer deadline; a selector that selects an offer among the offer from the one sales offerer or the offers from the plurality of sales offerers based on the sales condition of the accepted offer when the set offer deadline comes, sets the sales offerer with the selected offer as the second seller, and sets the sales condition of the selected offer as the second sales condition; an obtainer that obtains a stock quantity of the product for sale by the first seller under the first sales condition; and a releaser that releases an introductory text associated with the second sales condition in order to let the second seller start selling when the obtained stock quantity becomes zero.

The aforementioned recording medium can be a non-transitory recording medium, and can be distributed and sold separately from a computer. In this case, the non-transitory recording medium is a tangible recording medium. An example non-transitory recording medium is a compact disk, a flexible disk, a hard disk, a magneto-optical disk, a digital video disk, a magnetic tape, or a semiconductor memory. In addition, the term transitory recording medium is a carrier medium (a carrier signal) itself. An example transitory recording medium is an electric signal, an optical signal, or an electro-magnetic wave. Note that a temporary memory area is an area for temporary storing data and a program, and is, for example, a volatile memory like a RAM (Random Access Memory).

### Advantageous Effects of Invention

According to the present invention, it becomes possible to provide a selection device, a selection method, a program, and a recording medium which are suitable for selecting a seller who sells a commercial product.

### BRIEF DESCRIPTION OF DRAWINGS

FIG. 1 is a diagram illustrating a relationship among a selection device, a shopping server, a seller terminal, and a user terminal according to embodiments of the present invention;

FIG. 2 is a diagram illustrating example communications performed among the selection device, the shopping server, the seller terminal, and the user terminal;

FIG. 3 is a diagram illustrating a general configuration of a typical information processing device that embodies the selection device according to embodiments of the present invention;

FIG. 4 is a diagram illustrating a general configuration of a selection device according to a first embodiment;

FIG. 5 is a diagram for explaining an introductory text;

FIG. 6 is a diagram for explaining a sale offer accepting page;

FIG. 7 is a diagram for explaining a seller table;

FIG. 8 is a diagram for explaining a sales condition entering page;

FIG. 9 is a diagram for explaining a registered product table;

FIG. 10 is a diagram for explaining an offer record table;

FIG. 11 is a diagram for explaining a seller product table;

FIG. 12 is a diagram for explaining a sales condition entering page;

FIG. 13 is a flowchart for explaining a selecting process performed by each component of the selection device according to the first embodiment;

FIG. 14 is a diagram illustrating a general configuration of a selection device according to a second embodiment;

FIG. 15 is a diagram for explaining a change in a stock quantity; and

FIG. 16 is a flowchart for explaining a selecting process performed by each component of the selection device according to the second embodiment.

### DESCRIPTION OF EMBODIMENTS

Embodiments of the present invention will be explained below. The following embodiments are intended for explanation, and are not intended to limit the scope and spirit of the present invention. Hence, those skilled in the art can employ embodiments in which each component or all components are replaced with equivalents, and such embodiments should be within the scope and spirit of the present invention.

[1. Whole Configuration]

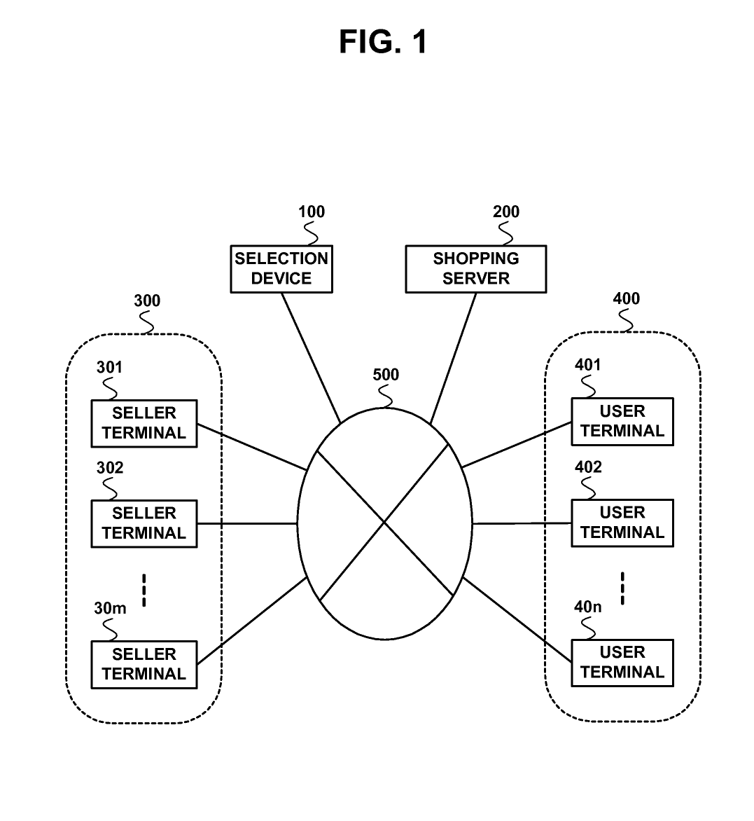

As illustrated in FIG. 1, a selection device 100 according to embodiments of the present invention is connected with the Internet 500. Connected to the Internet 500 are a shopping server 200, seller terminals 301, 302 to 30m (hereinafter, those are collectively referred to as a “seller terminal 300”), and user terminals 401, 402 to 40n (hereinafter, those are collectively referred to as a “user terminal 400”). The seller terminal 300 is a terminal utilized by a seller of a commercial product. The user terminal 400 is a terminal utilized by a user who browses for and purchases the commercial product from the seller. The shopping server 200 registers information on the commercial product transmitted from the seller terminal 300, and presents the information on the registered commercial product in response to a request from the user terminal 400. In addition, the shopping server 200 accepts an order for the commercial product from the user terminal 400, and transmits information on the order to the seller terminal 300. Hereinafter, such a sales configuration will be referred to as a “normal sales configuration”.

In addition, the shopping server 200 employs a sales configuration that accepts a sales consignation for the commercial product on behalf of multiple sellers, collects orders for the commercial products of the multiple sellers in the shopping server 200, and collectively ships the ordered commercial products to the user. Hereinafter, such a sales configuration is referred to as a “collective sales configuration”. For example, the commercial products of respective sellers are in advance stocked in a warehouse owned by a party managing the shopping server 200, and when a user places orders, the commercial products are collectively shipped from the warehouse. According to the collective sales configuration, it is possible for the user to purchase the commercial products across multiple stores, and such commercial products are collectively shipped from the warehouse, and thus there is an advantage that the shipping costs become less in comparison with the normal sales configuration in which the shipping costs are paid for respective sellers.

The selection device 100 limits the sellers (stores) to be one for each commercial product in the collective sales configuration, and selects one of the multiple sellers who desire to sell the commercial product. In the following explanation, in the collective sales configuration, a seller currently selected as a person who has a privilege to sell a commercial product is referred to as a “first seller”, and a seller selected as a person who has a privilege to sell the commercial product next to the first seller is referred to as a “second seller”.

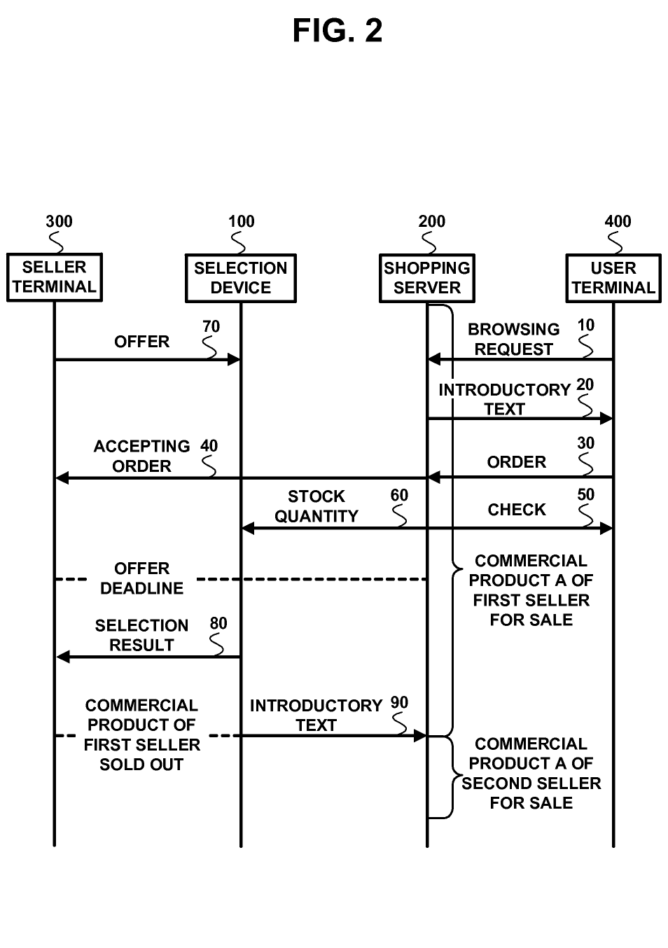

In the collective sales configuration, an explanation will be given of communications performed among the selection device 100, the shopping server 200, the seller terminal 300, and the user terminal 400 with reference to FIG. 2. FIG. 2 illustrates communications performed when a commercial product A is marketed and the second seller of the commercial product A is selected.

The user terminal 400 transmits a browsing request of an introductory text of the commercial product A to the shopping server 200 (10).

The introductory text is a text for introducing the price, specification, quality, and the like of the commercial product, and is, for example, a WEB page browsed on the user terminal 400.

The shopping server 200 transmits the introductory text of the commercial product A to the user terminal 400 in response to the browsing request (20). The introductory text transmitted by the shopping server 200 is an introductory text provided by the first seller who has a privilege to sell the commercial product A currently.

In addition, the user terminal 400 transmits an order for the commercial product A to the shopping server 200 (30).

The shopping server 200 transmits a notification of an order acceptance for the commercial product A to the seller terminal 300 utilized by the first seller so as to allow the seller to check the actual accomplishment of order acceptances of the commercial product (40).

Still further, the shopping server 200 transmits a confirmation notification regarding the order to the user terminal 400 (50). Next, the commercial product A is shipped to the user of the user terminal 400 from the warehouse stocking the commercial product A.

In addition, the shopping server 200 notifies the selection device 100 of the stock quantity of the commercial products A (60).

The selection device 100 accepts sales offers of the commercial product A from the seller terminals 300 while the commercial product A of the first seller is for sale through the shopping server 200, in order to select the second seller who sells the commercial product A next to the first seller. The seller terminals 300 transmit the sales offers to the selection device 100 (70).

The selection device 100 accepts offers from the seller terminal 300 until the offer deadline. Next, after the offer deadline has elapsed, the selection device 100 selects any one of the accepted offers. The selection device 100 notifies all seller terminals 300 that had transmitted the offers of the selection result (80). The seller who transmitted the selected offer ships the commercial product A to the warehouse of the manager of the shopping server 200 until the commercial products A of the first seller become sold out.

When the commercial products A of the first seller become sold out (when the stock quantity becomes zero), the selection device 100 releases the introductory text of the commercial product A provided by the second seller on the shopping server 200 (90). For example, the URL (Uniform Resource Locator) of the introductory text of the commercial product A released by the shopping server 200 is settled, and when the commercial products A of the first seller become sold out, the selection device 100 replaces the content of the introductory text provided by the first seller with the content of the introductory text provided by the second seller. In addition, for example, URLs different between the introductory text provided by the first seller and the introductory text provided by the second seller are allocated, and when the commercial products A of the first seller become sold out, the selection device 100 changes the URL of the introductory text of the commercial product A from the URL of the introductory text provided by the first seller to the URL of the introductory text provided by the second seller. The scheme of changing the introductory text from the introductory text provided by the first seller to the introductory text provided by the second seller is not limited to the above examples, and any arbitrary schemes are applicable as long as the introductory text provided by the first seller and the introductory text provided by the second seller are changed in a real-time manner when the commercial products of the first seller become sold out. Next, the shopping server 200 releases the introductory text provided by the second seller to the user terminal 400 after the commercial products A of the first seller become sold out, and starts the sales of the commercial product A consigned from the second seller.

Note that in the following embodiments, the selection device 100 and the shopping server 200 are connected through the Internet 500 as illustrated in FIG. 1, but the present invention is not limited to this example case. For example, the selection device 100 and the shopping server 200 may be embodied by the same device. Alternatively, the selection device 100 and the shopping server 200 may be directly connected with each other.

[2. General Configuration of Information Processing Device]

An explanation will be given of a typical information processing device 600 that embodies the selection device 100 according to embodiments of the present invention.

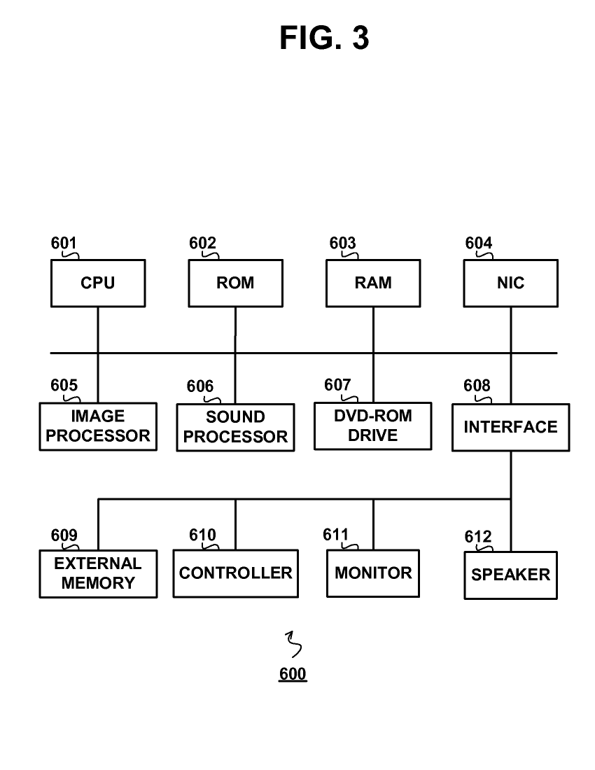

As illustrated in FIG. 3, an information processing device 600 includes a CPU (Central Processing Unit) 601, a ROM (Read Only Memory) 602, a RAM 603, an NIC (Network Interface Card) 604, an image processor 605, a sound processor 606, a DVD-ROM (Digital Versatile Disc ROM) drive 607, an interface 608, an external memory 609, a controller 610, a monitor 611, and a speaker 612.

The CPU 601 controls the operations of the whole information processing device 600, is connected with the respective components, and exchanges therewith control signals and data.

The ROM 602 records an IPL (Initial Program Loader) to be executed right after the power is turned on, reads a predetermined program in the RAM 603 upon execution of the IPL, and the CPU 601 starts executing such a program. In addition, the ROM 602 records an operating system program and various data necessary for controlling the operations of the whole information processing device 600.

The RAM 603 temporary stores data and a program, and stores a program and data both read from a DVD-ROM, and other data and the like necessary for a communication.

The NIC 604 is for connecting the information processing device 600 to a computer network such as the Internet, and has an interface (not illustrated in the figure) for acting as a go-between for devices such as a device according to the 10 BASE-T/100 BASE-T standard that is used when creating a LAN (Local Area Network), an analog modem, an ISDN (Integrated Services Digital Network) modem, an ADSL (Asymmetric Digital Subscriber Line) modem for connecting to the Internet using an telephone line, a cable modem for connecting to the Internet using a cable television line, and the like, and the CPU 601.

The image processor 605 allows the CPU 601 or an imaging processor (unillustrated) of the image processor 605 to process data read from the DVD-ROM or the like, and records the processed data in the frame memory (unillustrated) of the image processor 605. Image information recorded in the frame memory is converted into video signals at a predetermined synchronous timing, and output to the monitor 611. Hence, various kinds of pages can be displayed.

The sound processor 606 converts sound data read from the DVD-ROM or the like into analog sound signals, and causes the speaker 612 connected with the sound processor to output sound. In addition, the sound processor generates sound to be output during the advancement of the process executed by the information processing device 600 under the control of the CPU 601, and causes the speaker 612 to output sound corresponding to the generated sound.

The DVD-ROM loaded in the DVD-ROM drive 607 stores, for example, a program that realizes the selection device 100 of the embodiments. The DVD-ROM drive 607 performs a reading process on the DVD-ROM loaded therein under the control of the CPU 601, and reads necessary program and data. Those read program and data are temporary stored in the RAM 603 or the like.

The interface 608 is connected with, in a detachable manner, the external memory 609, the controller 610, the monitor 611, and the speaker 612.

The external memory 609 stores, in a rewritable manner, data on personal information of a user.

The controller 610 accepts inputting of operations performed at the time of various settings of the information processing device 600. The user of the information processing device 600 inputs an instruction through the controller 610 to record such input data in the external memory 609 as needed.

The monitor 611 presents data output by the image processor 605 to the user of the information processing device 600.

The speaker 612 presents sound data output by the sound processor 606 to the user of the information processing device 600.

Alternatively, the information processing device 600 may have a large-capacity external memory device like a hard disk that has the same function as that of the ROM 602, the RAM 603, the external memory 609, the DVD-ROM loaded in the DVD-ROM drive 607, and the like.

An explanation below will be given of the selection device 100 embodied over the information processing device 600 with reference to FIGS. 1 to 16. When the information processing device 600 is powered on, the program that causes the information processing device 600 to function as the selection device 100 of the embodiments is executed, and thus the selection device 100 of the embodiments is realized.

[3. General Configuration of Selection Device of First Embodiment]

The selection device 100 of this embodiment selects, in a collective sales configuration, a person having a privilege to sell a commercial product based on sales conditions specified when a seller makes an offer. More specifically, after the sales products (commercial products) sold by a first seller under a first sales condition become sold out, the selection device 100 selects a second seller who becomes able to sell the products under a second sales condition. The first sales condition is a sales condition specified when the first seller makes a sale offer, and the second sales condition is a sales condition specified when the second seller makes a sale offer.

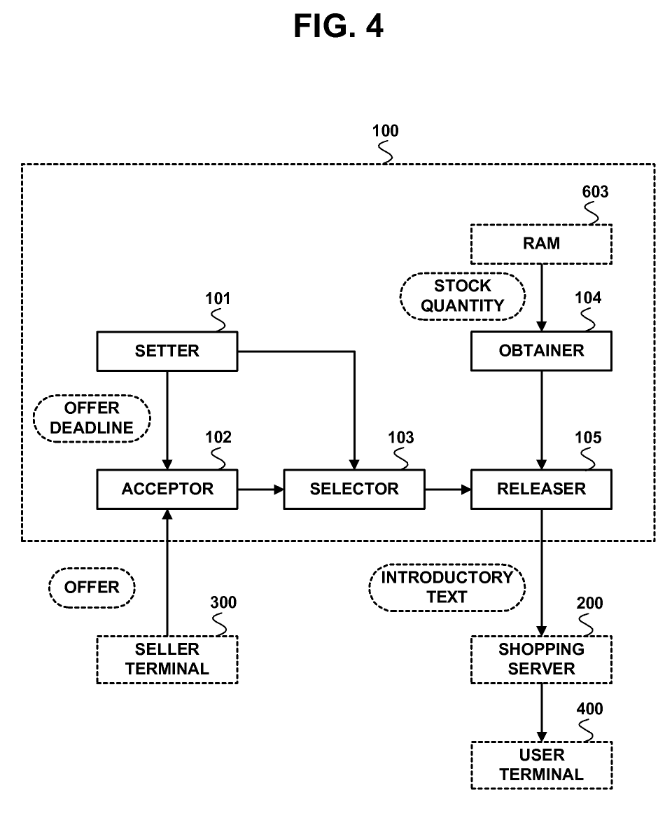

As illustrated in FIG. 4, the selection device 100 includes a setter 101, an acceptor 102, a selector 103, an obtainer 104, and a releaser 105.

The setter 101 sets an offer deadline.

The offer deadline can be set optionally by the manager and the like of the selection device 100. For example, the setter 101 sets the offer deadline that is a time three days after the commercial product A is sold by the first seller.

In this embodiment, the CPU 601 serves as the setter 101. The same is true in a second embodiment to be discussed later.

The acceptor 102 accepts offers of sales conditions of commercial products including at least the number of commercial products to be sold, the sale price, and the introductory text from one or multiple sales offerers until the set offer deadline. According to the first and second embodiments, it is presumed that an i-th offer deadline for an i-th seller selected by the selector 103 is an i+1 th offer start time to select an i+1 th seller. The acceptor 102 accepts offers from the offer start time to the offer deadline.

The sales offerer is a person who wants to sell the commercial product after the commercial products of the first seller become sold out. The sales offerer specifies, at the time of offering, the stock quantity to be delivered to the warehouse of the shopping server 200, a desired sale price, and the introductory text all for the commercial product, in the collective sales configuration.

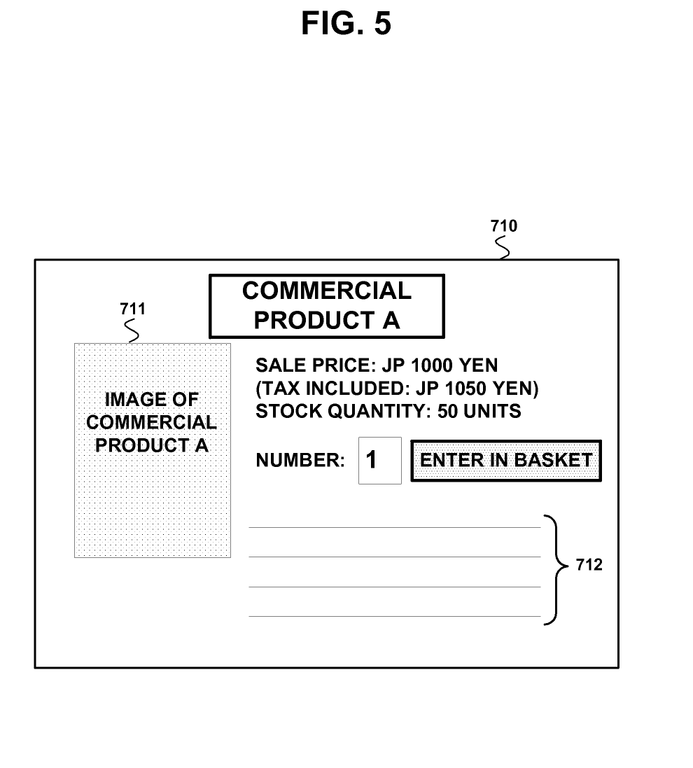

FIG. 5 illustrates an example introductory text. An introductory text 710 contains, in addition to the sale price of the commercial product and the stock quantity thereof, an image 711 of the commercial product, a detailed explanation 712 thereof, and the like.

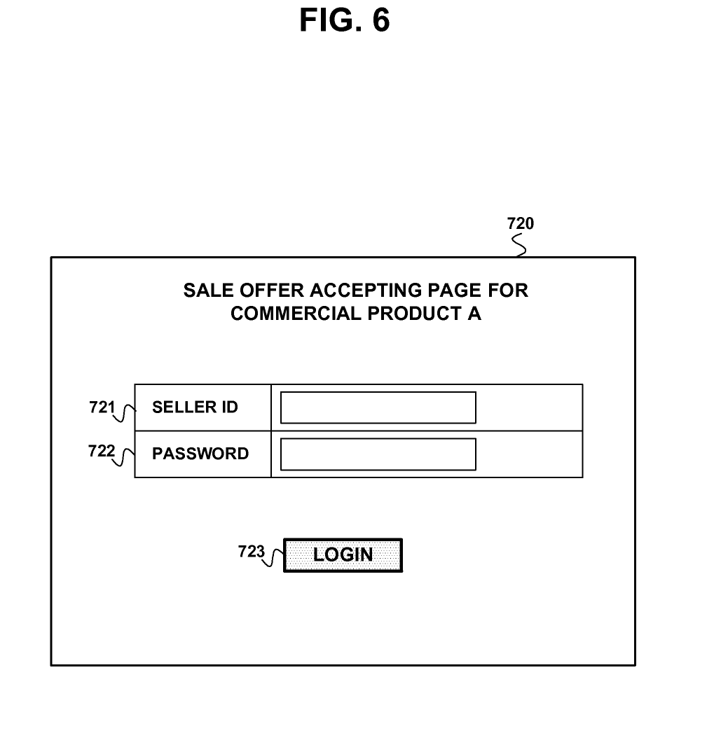

When accepting an access from the seller terminal 300 that desires an offer, the acceptor 102 presents a page (hereinafter, referred to as a “sale offer accepting page”) to specify the seller, and allows the seller to enter an ID and a password. FIG. 6 illustrates an example sale offer accepting page. A sale offer accepting page 720 contains a seller ID 721, a password 722 registered in advance, and a login button 723.

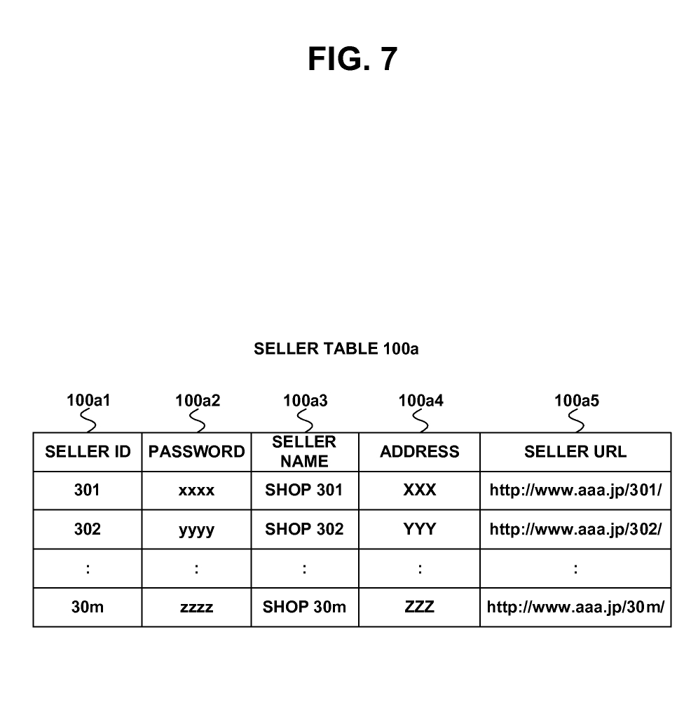

For example, the RAM 603 and the like of the selection device 100 stores a table (hereinafter, referred to as a “seller table 100a”) that registers information on stores selling the commercial products on the shopping server 200. The acceptor 102 refers to the seller table 100a, and specifies the offering seller. For example, as illustrated in FIG. 7, the seller table 100a registers, in association with each other, a seller ID 100a1 to specify the seller, a password 100a2 registered in advance, a seller name 100a3 of the seller, an address 100a4 of the seller, and a seller URL 100a5 of the seller released on the shopping server 200.

For example, the first row of FIG. 7 indicates that the combination of the seller ID “301” and the password “xxxx” shows the seller of a “shop 301”, and indicates that the address of the seller is “XXX” and the URL of the seller is “http://www.aaajp/301/”.

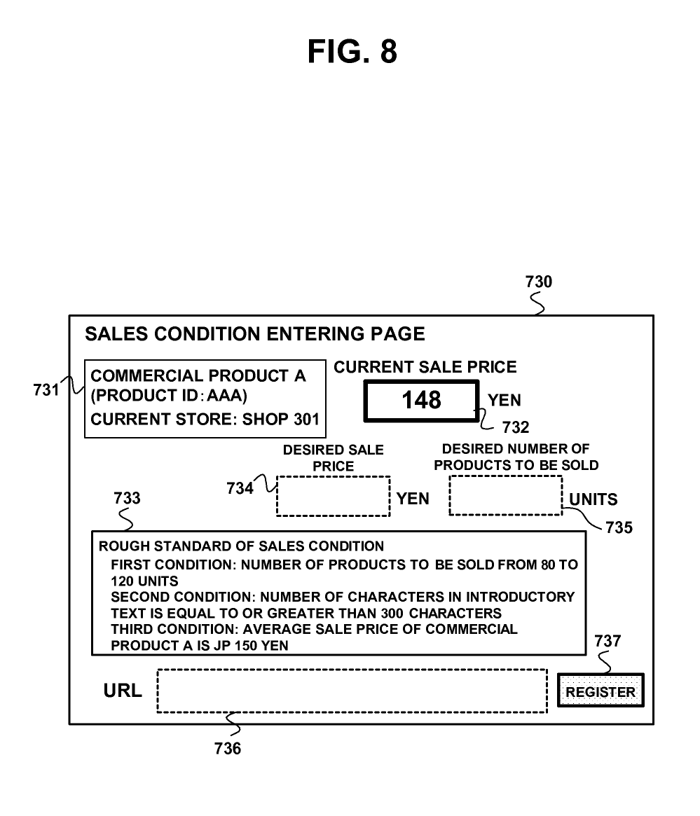

In the sale offer accepting page 720, when correct seller ID and password are entered and the login button 723 is clicked, the acceptor 102 next presents a page (hereinafter, referred to as a “sales condition entering page”) to register the detail of the sales condition to the seller terminal 300, and allows the user to enter the detail of the sales condition on such a page. FIG. 8 illustrates an example sales condition entering page. A sales condition entering page 730 contains information 731 including the product ID of the commercial product, the product name, and the first seller currently selling that product, a field 732 of the current sale price, a field 733 of a rough standard of the sales condition, a field 734 of a desired sale price, a field 735 of a desired number of products to be sold, a field 736 of the URL of the introductory text, and a register button 737. The field 733 of the rough standard of the sales condition recites a desired number of products consigned to be sold on the shopping server 200, the desired number of characters in the introductory text, an average sale price of the commercial product, and the like. The first sales condition of the first seller currently selling the commercial products may be presented.

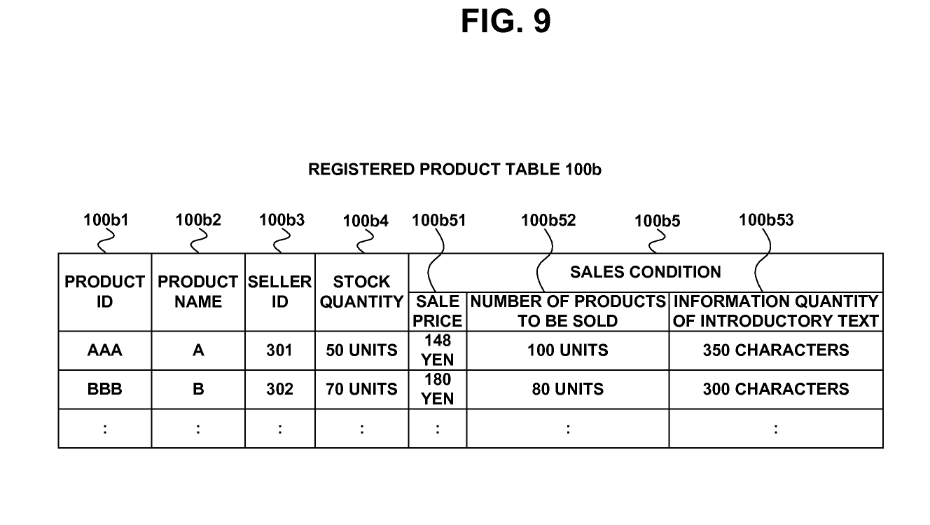

For example, the RAM 603 and the like of the selection device 100 stores a table (hereinafter, referred to as a “registered product table 100b”) registering information on the commercial products handled through the collective sales configuration. The acceptor 102 refers to the registered product table 100b, and obtains information to be presented on the sales condition entering page. For example, as illustrated in FIG. 9, the registered product table 100b registers, in association with each other, a product ID 100b1 to identify the commercial product, a product name 100b2 of the commercial product, a seller ID 100b3 to identify the seller currently selling the commercial product, a current stock quantity 100b4 of the commercial products, and a current sales condition 100b5. That is, the seller indicated by the seller ID 100b3 registered in the registered product table 100b is the first seller, and the sales condition 100b5 is the first sales condition.

The product ID 100b1 is, for example, a JAN (Japanese Article Number) code or an arbitrary identifier utilized by the manager of the shopping server 200. The sales condition 100b5 contains, for example, a sale price 100b51, a number of products 100b52 to be sold, and information quantity 100b53 of the introductory text.

The sale price 100b51 is a price presented by the first seller. The number of products 100a52 to be sold is the number of commercial products consigned by the first seller. The information quantity 100b53 of the introductory text is, for example, the number of characters in the introductory text provided by the first seller. The seller ID 100b3 and the sales condition 100b5 are changed every time the seller of the commercial product is changed from the first seller to the second seller, that is, every time the stock quantity 100b4 becomes zero. In addition, the stock quantity 100b4 is changed every time the commercial product is traded on the shopping server 200.

For example, the first row in FIG. 9 indicates that the sales of the 100 units of commercial product A is consigned by the “shop 301” of the seller with the seller ID “301” at a sale price of JP 148 YEN, the current stock quantity is 50, and the introductory text of the commercial product A released on the shopping server 200 is “350 characters”. The acceptor 102 displays the current seller (the first seller), the sale price, and the like with respect to the commercial product A in the sales condition entering page based on the aforementioned information. The rough standard of the sales condition can be set by the manager as needed, or may be automatically set upon obtaining an average and the like from the past record of the first seller.

The sales offerer refers to the current sale price and other sales conditions recited in the sales condition entering page, and enters the desired sale price of the commercial product A in the field 734, the desired number of products to be sold in the field 735, and the URL of the introductory text of the commercial product A prepared by the sales offerer himself/herself in the field 736. Next, when the register button 737 is clicked, the offer completes, and the acceptor 102 accepts this offer.

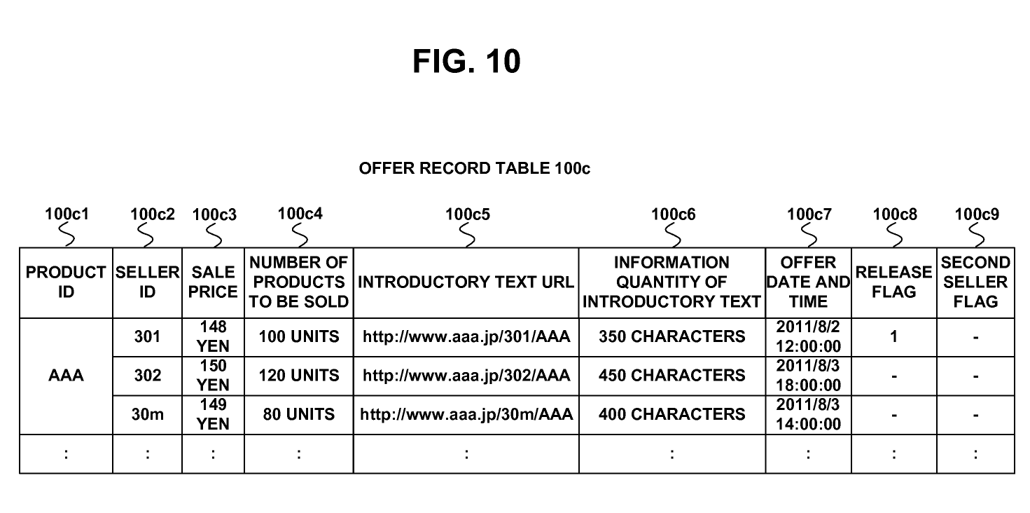

When accepting the offer from the seller terminal 300, the acceptor 102 registers this offer in, for example, a table (hereinafter, referred to as an “offer record table 100c”). The offer record table 100c is stored in, for example, the RAM 603 or the like. For example, as illustrated in FIG. 10, the offer record table 100c registers, in association with each other, a product ID 100c1 of the commercial product, a seller ID 100c2 to specify the sales offerer, a sale price 100c3 specified by the sales offerer, a number of products 100c4 to be sold, an introductory text URL 100c5, an information quantity 100c6 of the introductory text, an offer date and time 100c7 at which the offer was accepted, a release flag 100c8, and a second seller flag 100c9.

The information quantity 100c6 of the introductory text is, for example, the number of characters contained in the introductory text represented by the introductory text URL specified by the sales offerer. The information quantity 100c6 of the introductory text is obtained by the acceptor 102, for example, when the acceptor 102 accepts the offer. Alternatively, when it becomes the offer deadline, the selector 103 may obtain the information quantity together with a selection of the second seller.

The release flag 100c8 indicates whether or not the introductory text URL 100c5 is currently released as the introductory text of the commercial product A on the shopping server 200 under the collective sales configuration. An offer record containing the introductory text URL currently released is set as a release flag “1”.

The second seller flag 100c9 indicates who is the second seller selected by the selector 103 among the sales offerers. When it becomes the set offer deadline, the selector 103 performs a process of selecting the second seller among the sales offerers, and it is set as a second seller flag “1” in the offer record of the sales offerer selected as the second seller.

The offer record table 100c in FIG. 10 indicates that the sellers with seller IDs “301”, “302”, and “30 m” made an offer with respect to the commercial product A. It is presumed that a current time does not reach the offer deadline yet. Hence, no second seller flag is set in any records. For example, the second row of the offer record table 100c in FIG. 10 indicates that the acceptor 102 accepted on Aug. 3, 2011, 18 O'clock an offer from the seller of the seller ID “302” specifying that the sale price is “JP 150 YEN”, the number of products to be sold is “120 product units”, and the URL of introductory text is “http://www.aaa.jp/302/AAA” regarding the commercial product A with a product ID “A”. In addition, the first row of the offer record table 100c in FIG. 10 indicates an offer record by the seller “shop 301” with the seller ID “301” that is the first seller. The seller “shop 301” desires to sell newly 100 commercial products A in a consigned manner after the commercial products A currently consigned become sold out. Since the introductory text provided by the seller “shop 301” is currently released, the release flag “1” is set.

It is fine if the introductory text URL is not specified in the sales condition entering page. For example, in the sale offer accepting page, when the seller who offers sales is specified, it becomes possible for the shopping server 200 to specify the introductory text (WEB page) of the commercial product A utilized in the normal sales configuration by that seller. Accordingly, the URL of such an introductory text may be specified as the URL of the introductory text associated with an offer. In this case, when the seller wants to change the introductory text utilized in the normal sales configuration, the seller may be allowed to specify the new URL of the introductory text.

In addition, each seller may register in advance the introductory text created for a commercial product to be offered and the sales condition thereof prior to making an offer. Next, when the acceptor 102 specifies the seller, information on the introductory text and the sales condition registered in advance may be displayed in a manner already entered in the sales condition entering page.

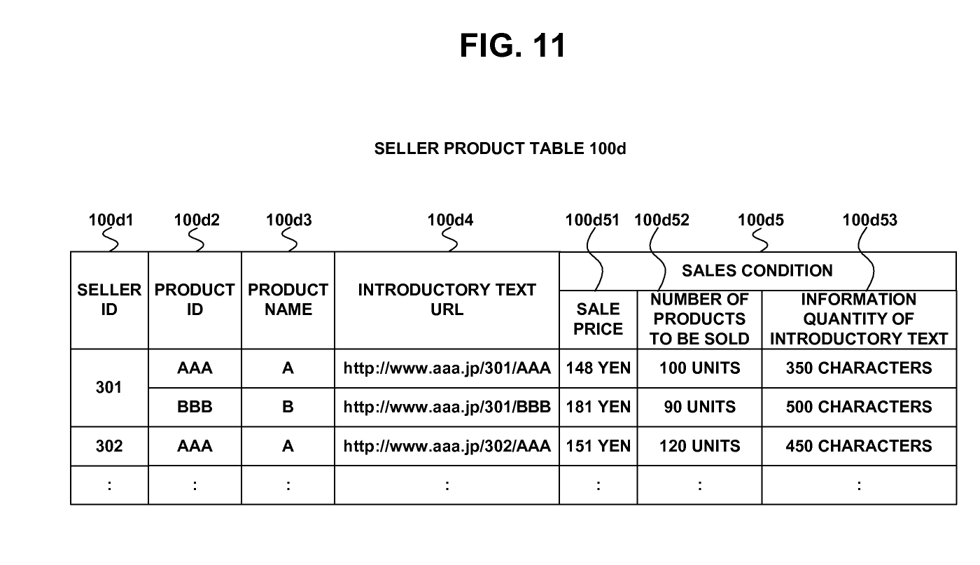

For example, the RAM 603 and the like of the selection device 100 stores a table (hereinafter, referred to as a “seller product table 100d”) that registers information on the introductory text and the sales condition registered before the seller made an offer. For example, as illustrated in FIG. 11, the seller product table 100d registers, in association with each other, a seller ID 100d1, a product ID 100d2 of the commercial product, a product name 100d3, an introductory text URL 100d4 of the commercial product, and a sales condition 100d5. The sales condition 100d5 contains a sale price 100d51 desired by the sales offerer, a desired number of products 100d52 to be sold, and an information quantity 100d53 of the introductory text indicated by the introductory text URL 100d4. The acceptor 102 specifies the sales offerer when accepting correct seller ID and password from the seller terminal 300, refers to the seller ID and the seller product table 100d, and specifies the introductory text URL of the sales offerer and the sales condition thereof. Next, the acceptor 102 displays the specified introductory text URL and sales condition in a manner entered in the sales condition entering page.

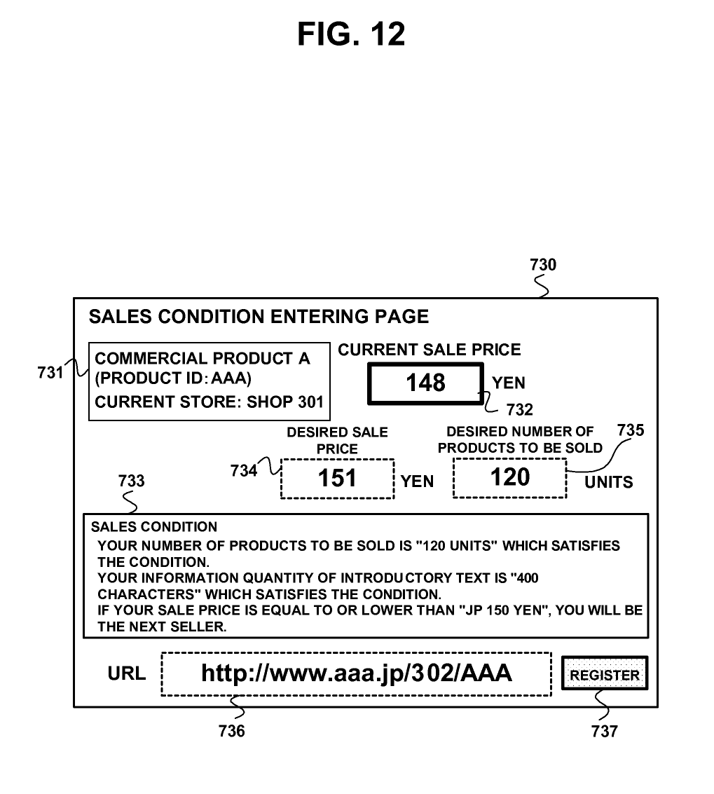

When, for example, a seller “shop 302” specifies the seller ID and the password through the sale offer accepting page, and the acceptor 102 specifies that the sales offerer is “shop 302”, as illustrated in FIG. 12, the sale offer accepting page is displayed with the field 734 filled with “JP 151 YEN” of the sale price 100d51 of the seller product table 100d (see FIG. 11), the field 735 filled with “120 products” of the number of products 100d52 to be sold, and the field 736 filled with “http://www.aaa.jp/302/AAA” of the introductory text URL 100d4.

When the sales offerer “shop 302” changes the desired sale price (the field 734) to be “JP 150 YEN” in the sales condition entering page (see FIG. 12), and clicks the register button 737, the acceptor 102 accepts an offer specifying the details entered in the fields 734, 735, and 736. Next, the acceptor 102 registers, as illustrated in FIG. 10, the sale price “JP 150 YEN” specified in the offer in the offer record table 100c.

As explained above, when the introductory text and the sales condition are registered in advance, and an acceptance of an offer can be completed by only checking the entered details and changing the desired sale price and the like in the sales condition entering page, the necessary time for the seller to enter information can be reduced.

The store table 100a, the registered product table 100b, the offer record table 100c, or the seller product table 100d may be stored in the shopping server 200, and the selection device 100 may refer to such a table through the Internet or the like.

Moreover, the sales condition entering page presented by the acceptor 102 is not limited to the example illustrated in FIG. 8. For example, a condition to be selected by the selection device 200 as the second seller may be presented. For example, when the number of products to be sold and the information quantity of the introductory text are better than those of the first seller and other sales offerers, but the sale price is high, and the selector 103 determines that the subject seller will be not selected without any change, as illustrated in a field 733 in FIG. 12, the acceptor 102 may present a sale price so as to be selected.

In this embodiment, the CPU 601, the NIC 604, and the image processor 605 work together to function as the acceptor 102. The same is true in the second embodiment to be discussed later.

When it becomes the set offer deadline, the selector 103 selects one offerer from one or multiple offerers based on the sales condition with respect to the accepted offers, sets the sales offerer with respect to the selected offer as the second seller, and sets the sales condition with respect to the selected offer as the second sales condition.

More specifically, the selector 103 selects an offer having a highest score determined based on the sale price contained in the sales condition, the number of products to be sold contained in the sales condition, and the information quantity of the introductory text contained in the sales condition. The lower the sale price is, the greater the number of products to be sold is, and the greater the information quantity of the introductory text is, the higher the score is set.

In this case, the information quantity of the introductory text may be defined by, in addition to the number of characters in the introductory text, the number of images or the image size. That is, the greater the number of characters or the number of images, or the larger the image size is, the greater the information quantity becomes, and a higher score is set. Alternatively, among the accepted offers, the information quantity of the introductory text of a given offer may be defined by the number of words not appearing in the introductory texts of the other offers. That is, the greater the number of words not appearing in the introductory texts of the other offers is, the greater the information quantity is, and a higher score is obtained.

Alternatively, the score with respect to the information quantity of the introductory text may be defined whether or not the introductory text satisfies a predetermined format. For example, the score may be obtained in such a way that when the number of characters in the explanatory sentence in the introductory text is equal to or greater than 400 characters, “one point” is counted, and when the number of image is equal to or greater than two, “one point” is counted. In addition, information advantageous to the user may be set in advance based on the kind of the commercial product such that when the commercial product is foods, if the pack date and the expiration date are noted, “one point” is counted, and when the commercial product is an electric appliance, if the durable period is noted, “one point” is counted, and a score may be increased when such information is noted.

For example, the selector 103 refers to the offer record table 100c, and counts the score such that the lowest sale price is “10 points” and the next lowest sale price is “9 points” among the accepted offers, and likewise, counts the score such that “10 points”, “9 points”, “8 points”, and the like in the order from the greatest with respect to the number of product to be sold and the information quantity of the introductory text. Next, the selector 103 sums up the score for the sale price, the score for the number of products to be sold, and the score for the information quantity of the introductory text, and selects the seller who made an offer with the highest score.

An explanation will be given of an example case in which the selector 103 selects the second seller based on the offer record table 100c in FIG. 10. With reference to the offer record table 100c in FIG. 10, the total score of the sales condition of the “shop 301” is 27 points (sale price: 10 points, number of products to be sold: 9 points, and information quantity of introductory text: 8 points), the total score of the sales condition of the “shop 302” is 28 points (sale price: 8 points, number of products to be sold: 10 points, and information quantity of introductory text: 10 points), and the total score of the sales condition of the “shop 30 m” is 26 points (sale price: 9 points, number of products to be sold: 8 points, and information quantity of introductory text: 9 points). Hence, the selector 103 selects the “shop 302” as the second seller, and sets the sales condition specified by the “shop 302” through the offer as the second sales condition. In addition, in the offer record table 100c, the selector 103 sets a second seller flag 100c9 in the offer record of the “shop 302” to be “1”.

When the sale price is low, it becomes likely to be purchased by the user. In addition, the greater the number of products to be sold is, the less the possibility of becoming out of stock, and thus it becomes possible to reduce the loss of a purchase opportunity by the user. Still further, the greater the information quantity of the introductory text is, the more the user can obtain information on the commercial product, which facilitates the user to determine whether or not to purchase. Accordingly, when the seller is selected who made an offer presenting the sales condition with a high score, it becomes possible to select the seller who is most likely to be utilized by the user.

The scoring may be performed by weighting for each commercial product. For example, it is expected that the user needs no detailed information on the commercial product that is generally well known, and there is no contribution for the purchase by the user even if there is a large quantity of information in the introductory text. In this case, a total score may be obtained with a contribution rate being set to be lower than the score obtained based on the sale price and the number of products to be sold. When, for example, the score for the sale price is “10 points”, the score for the number of products to be sold is “6 points”, and the score for the information quantity of the introductory text is “8 points”, the contribution rate of the score of the information quantity of the introductory text is set to be “0.5”, and the total score is obtained as 10 points×1.0+6 points×1.0+8 points×0.5=20 points.

The score for the information quantity of the introductory text may be not for each introductory text of the commercial product, but the information quantity of all introductory texts released by the sales offerer on the shopping server 200 in the normal sales configuration or the information quantity of the introductory text of the commercial product belonging to the same category as the offered commercial product may be obtained, and the score may be obtained based on the average of those information quantities, the most frequent value, and the like.

The greater the number of products to be sold is, the higher the score is set, but the present invention is not limited to this example. For example, an appropriate number of products to be sold may be set, and the closer the number of products to be sold is to such an appropriate number, the higher the score is set. When, for example, the number of products consigned to be sold is small, it becomes out of stock soon, which is not preferable, but the available space of the warehouse is limited for the manager of the shopping server 200, and thus it is not suitable for the manager if too much commercial products are delivered at once. In this case, the seller who delivers an appropriate number of commercial products at an appropriate cycle is preferable for the manager. Hence, when it is set that the closer the number of products to be sold is to the number of products set by the manager, the higher the score becomes, it becomes possible to select the seller in consideration of the convenience of the manager in addition to the user.

In addition, after selecting the second seller, the selector 103 may notify the sales offerer of the selection result. In this case, the selector 103 may notify the sales offerer who made an offer but is not selected of the fact that the sales offerer is not selected and the reason why this sales offerer is not selected. For example, in the aforementioned example, the selector 103 notifies the “shop 301” that the number of products to be sold and the information quantity of the introductory text are less competitive than those of the other sales offerer, and thus this shop is not selected.

In this embodiment, the CPU 601 and the NIC 604 work together to function as the selector 103. The same is true in the second embodiment to be discussed later.

The obtainer 104 obtains the stock quantity of the products currently for sale by the first seller under the first sales condition.

For example, the obtainer 104 refers to the stock quantity 100b4 in the registered product table 100b, and obtains that the current stock quantity of the commercial product A is “50 products”.

In this embodiment, the CPU 601 and the NIC 604 work together to function as the obtainer 104. The same is true in the second embodiment to be discussed later.

The releaser 105 releases the introductory text with respect to the second sales condition to let the second seller start selling when the obtained stock quantity becomes zero.

For example, the releaser 105 refers to a release flag 100c8 and the second seller flag 100c9 in the offer record table 100c, specifies the currently released introductory text and the next introductory text to be released, and changes the introductory text when the stock quantity of the first seller becomes zero. When, for example, the release flag 100c8 of the “shop 301” is set to be “1”, and the second seller flag 100c9 of the “shop 302” is set to be “1”, the releaser 105 releases the introductory text “http://www.aaa.jp/302/AAA” for accepting the sales of the commercial product A by the “shop 302”, when the commercial product A of the “shop 301” becomes sold out, and makes the introductory text “http://www.aaa.jp/301/AAA” undisclosed. While at the same time, the releaser 105 updates the offer record table 100c. That is, the release flag 100c8 of the “shop 302” is set to be “1”, and the release flag 100c8 of the “shop 301” and the second seller flag 100c9 of the “shop 302” are deleted.

When the commercial product of the first seller becomes sold out, with reference to the updated offer record table 100c, the contents of the product registered table 100b are updated. When, for example, the commercial product A of the first seller that is “shop 301” becomes sold out, the releaser 105 refers to the updated offer record table 100c, and updates the seller ID 100b3 in the registered product table 100b in FIG. 9 to be “302”, the stock quantity 100b4 to be “120 product units”, the sale price 100b51 to be “JP 150 YEN”, the number of product units 100b52 to be sold to “120 product units”, and the information quantity 100b53 of the introductory text to be “450 characters”.

In addition, in the sales condition entering page where the sale price and the like are entered based on the seller product table 100d, it is presumed that the offer having the desired sale price changed by the seller is selected by the selector 103. In this case, the releaser 105 automatically corrects the portion of the introductory text registered in advance with respect to the sale price, and releases the corrected introductory text.

For example, it is presumed that the sale price for the commercial product A of the “shop 302” is registered as “JP 151 YEN” in the seller product table 100d (see FIG. 11), but the sales offerer changes the desired sale price to be “JP 150 YEN” in the sales condition entering page. In this case, the changed desired sale price “JP 150 YEN” is registered in the offer record table 100c. The releaser 105 refers to the sale price 100c3 in the offer record table 100c, changes the sale-price portion of the introductory text “http://www.aaa.jp/302/AAA” from “JP 151 YEN” to “JP 150 YEN”, and releases the changed introductory text.

The releaser 105 configured in this manner allows the seller to not correct the introductory text every time a change is made, and eliminates a problem such that the sale price specified when an offer is made becomes inconsistent with the sale price mentioned in the introductory text.

The releaser 105 may release the introductory text provided by the second seller before the number of stocks of the commercial product A by the first seller becomes zero. In this case, the introductory text provided by the second seller is browsable through the user terminal 400, but the sales of the commercial product A by the second seller is not started yet, and the shopping server 200 does not accept an order for the commercial product A of the second seller.

In this embodiment, the CPU 601, the NIC 604, and the image processor 605 work together to function as the releaser 105. The same is true in the second embodiment to be discussed later.

Next, when the products sold by the first seller under the first sales condition become sold out, with the second seller being as a new first seller, the obtainment by the obtainer 104, the setting by the setter 101, and the selection by the selector 103 are performed, thereby selecting a new second seller, and successive operations are repeated. In addition, the second sales condition is registered in the registered product table 100b as the first sales condition.

[4. Operation of Selection Device According to First Embodiment]

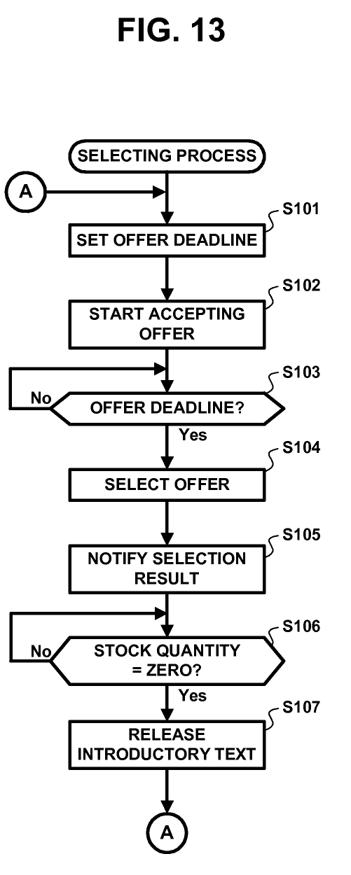

Next, an operation of the selection device 100 according to this embodiment will be explained. When the selection device 100 is powered on, the CPU 601 starts a selecting process illustrated in FIG. 13.

The setter 101 sets an offer deadline (step S101).

For example, the setter 101 sets a time three days after the first seller that is the “shop 301” starts selling the commercial product A as the offer deadline.

The acceptor 102 accepts, from the seller that operates the seller terminal 300, an offer with the sales condition containing the number of products to be sold, the sale price and the introductory text (step S102).

For example, with respect to the commercial product A, the acceptor 102 presents the sale offer accepting page in FIG. 6 and the sales condition entering page in FIG. 8 to the seller terminal 300. Next, for example, an offer from the “shop 302” specifying that the sale price is “JP 150 YEN”, the number of products to be sold is “120 product units”, and the URL of the introductory text is “http://www/aaa.jp/302/AAA” is accepted, and information on the sale price and the like with respect to the offer is registered in the offer record table 100c.

Next, the acceptor 102 determines whether or not the current time is the offer deadline (step S103). When determining that the current time is the offer deadline (step S103: YES), the acceptor 102 terminates the acceptance of the offers, and selects one offer among the accepted offers (step S 104). Subsequently, the selector 103 transmits the selection result to the seller terminal 300 that has transmitted the offer (step S105). Conversely, when determining that the current time is not the offer deadline (step S103: NO), the acceptor 102 stands by as it is.

When, for example, three days have past since the first seller that is the “shop 301” started selling the commercial product A, the acceptor 102 terminates the acceptance of the offers from the sales offerers, and the selector 103 refers to the offer record table 100c (see FIG. 10) to select one offer from the registered offer records. The selector 103 obtains the score for the sales condition, and selects the offer with respect to the sales condition with a high score. When selecting the “shop 302” as the second seller, the selector 103 notifies the “shop 302” of the selection, and notifies the “shop 301” and the “shop 30 m” of the fact that such shops are not selected and the reason thereof. In addition, in the offer record table 100c (see FIG. 10), the selector 103 sets the second seller flag 100c9 of the “shop 302” to be “1”. Conversely, when three days have not past since the first seller that is the “shop 301” started selling the commercial product A, the acceptor 102 keeps accepting the offers.

Next, the obtainer 104 obtains the stock quantity of the commercial products consigned by the first seller, and determines whether or not the stock quantity is zero (step S106). When the obtainer 104 determines that the stock quantity is zero (step S106: YES), the releaser 105 releases the introductory text provided by the second seller corresponding to the seller (offerer) selected through the process in the step S104 on the shopping server 200 (step S107). Conversely, when the obtainer 104 determines that the stock quantity is not zero (step S106: NO), the obtainer stands by as it is.

When, for example, the obtainer 104 refers to the stock quantity 100b4 in the registered product table 100b and determines that the stock quantity is zero, the releaser 105 starts releasing the introductory text “http://www.aaa.jp/302/AAA” of the “shop 302”. Conversely, when the obtainer 104 determines that the stock quantity is not zero, the obtainer 104 keeps referring to the stock quantity 100b4 and stands by.

Next, the process returns to the step S101, the second seller is set as the first seller, and the second sales condition is set as the first sales condition, and, the processes subsequent to the step S101 are repeated.

For example, the “shop 302” selected as the second seller by the selector 103 is registered as the first seller in the registered product table 100b and the desired sale price and the like presented by the “shop 302” are registered therein as the first sales condition. Subsequently, in order to select a new second seller, the acceptor 102 accepts offers.

According to this embodiment, the seller is limited to only one for a commercial product, and thus it becomes easy for the user to smoothly purchase the commercial product without the needs for comparison and checking with respect to the same commercial product. In addition, since the change of the seller is executed after the stock quantity of the first seller becomes zero, it becomes unnecessary to return the stocked products, and the seller or the manager needs no time-consuming procedure. Still further, other factors than the sale price are taken into consideration for the selection of the seller, thereby suppressing a price competition among the sellers. Moreover, the seller is selected in consideration of the information quantity of the introductory text for the commercial product, and thus the contents made available to the public on the shopping server 200 can be enriched. Yet further, the introductory text registered on the shopping server 200 by the selected seller is directly released, and thus a time-consuming step when making a sale offer can be eliminated.

In this embodiment, the product ID is a common ID among the sellers, but the present invention is not limited to this case. For example, each seller may have a unique ID to identify the commercial product. In this case, the selection device 100 identifies the commercial product using an ID (for example, a “brochure ID”) to identify the commercial product handled by the shopping server 200. For example, the product ID on the WEB page in FIG. 8 and the product ID in each table like the registered product table 100b are replaced with the brochure IDs. A product ID uniquely allocated by the seller may be registered in each table.

When the brochure ID is utilized, for example, the selection device 100 has a table that indicates the correspondence relationship among the seller ID, the product ID allocated by the seller with that seller ID, and the brochure ID. When the seller terminal 300 transmits an offer with a unique product ID specified, the selection device 100 refers to the table indicating the correspondence relationship, and obtains the brochure ID from the seller ID and the product ID. Alternatively, the table indicating the correspondence relationship may be possessed by each seller terminal 300, and an offer specifying the brochure ID may be automatically transmitted to the selection device 100 when an offer with a unique product ID specified is made.

[5. General Configuration of Selection Device According to Second Embodiment]

The selection device 100 of this embodiment is capable of setting the offer deadline based on the sold-out date and time of the commercial product.

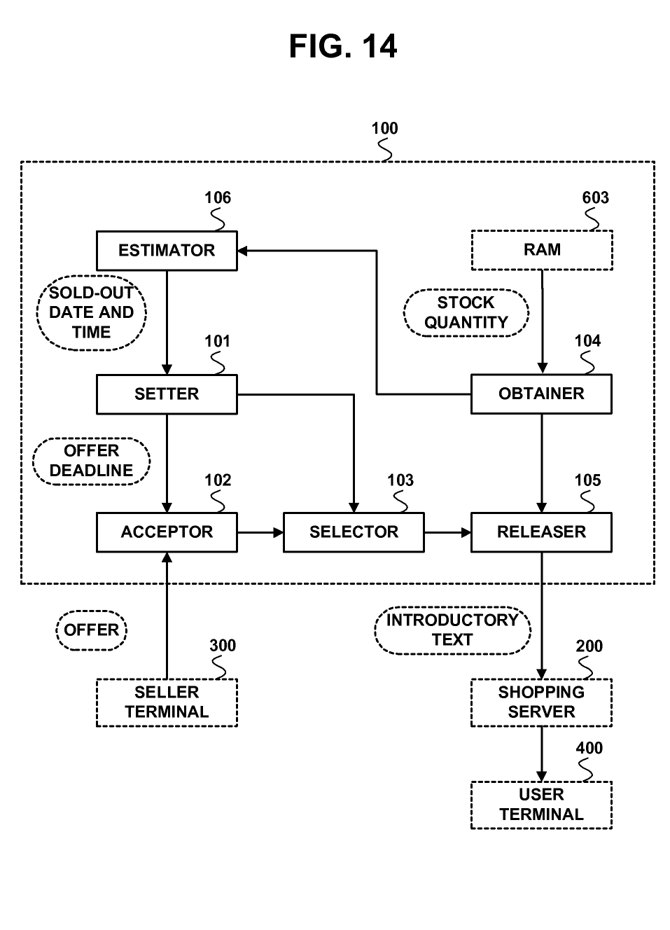

As illustrated in FIG. 14, the selection device 100 includes a setter 101, an acceptor 102, a selector 103, an obtainer 104, a releaser 105, and an estimator 106. In this embodiment, the selector 103, the obtainer 104, and the releaser 105 have the same function as those of the first embodiment. An explanation will be below given of the setter 101, the acceptor 102, and the estimator 106 having different functions.

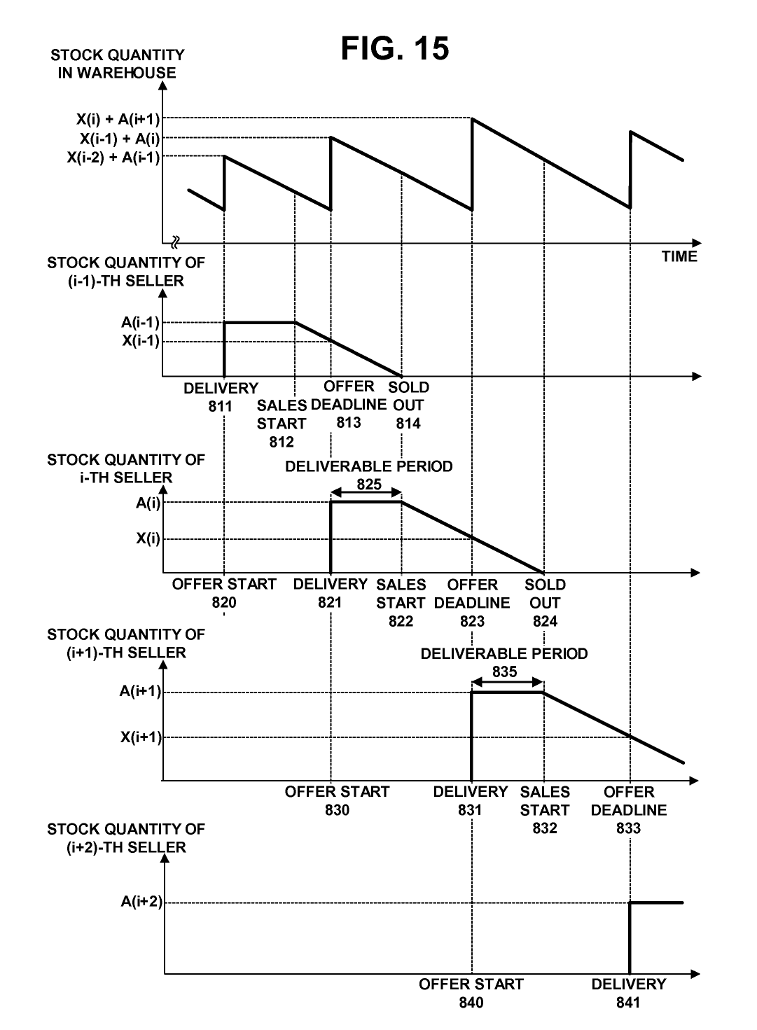

FIG. 15 illustrates an example case in which the stock quantity of the commercial product A changes in the collective sales configuration. When, for example, the current stock quantity of the commercial product A in the warehouse is X(i−2) units, and the first seller that is an (i−1)th seller delivers A(i−1) numbers of the commercial products A (delivery 811), the stock quantity in the warehouse becomes X(i−2)+A(i−1). Next, after the (i−1)th seller starts selling the commercial product A (sale start 812), it becomes the offer deadline (offer deadline 813) after a short time, and an i-th seller that is the second seller is selected, and the i-th seller delivers A(i) units of commercial product A (delivery 821). At this time, the stock quantity in the warehouse becomes X(i−1)+A(i) obtained by an addition with the stock quantity X(i−1) of the commercial product A by the first seller. Next, when the commercial product A by the first seller becomes sold out (sold out 814), the sales of the commercial product A of the i-th seller starts (sales start 822). In addition, the time point that becomes the offer deadline 813 is an offer start time (offer start 830) for selecting the i+1th seller. The functions of the estimator 106, the setter 101, and the acceptor 102 will be explained below with reference to the example case in FIG. 15.

In the example case illustrated in FIG. 15, deliveries 821 and 831 are carried out simultaneously with the offer deadlines 813 and 823 for the purpose of explanation, but in practice, deliveries are carried out a few days after the offer deadline.

The estimator 106 estimates, based on the obtained stock quantity, the sold-out date and time at which the product (commercial product) currently sold by the first seller under the first sales condition becomes sold out.

For example, in the collective sales configuration, it is presumed that the 100 units of commercial product A are delivered from the first seller, and 20 commercial product A's are sold per a day. In this case, it is estimated that the commercial products A delivered by the first seller will be sold out within five days. When it is presumed that the sales of the commercial product A delivered by the first seller starts at Aug. 1, 2011, 12:00, the estimator 106 estimates that the sold-out date and time is Aug. 6, 2011, 12:00 which is five days after the sale start date and time. In the example case illustrated in FIG. 15, the sold-out date and time can be estimated based on the inclinations of sales starts 812, 822, and 832.

It is not limited that the estimator 105 refers to the sales in the collective sales configuration to estimate the sold-out date and time, but the estimator 106 may estimate the sold-out date and time of the commercial product based on the sales accomplishment of the commercial product by the first seller in the normal sales configuration. When, for example, in the collective sales configuration, the sales accomplishment is little but the sales accomplishment in the normal sales configuration is great, the sold-out date and time can be estimated more precisely.

In addition, depending on, for example, the season of the sales, the actual sold-out date and time may vary from the sold-out date and time estimated based on the past sales. Hence, the estimator 105 may estimate the sold-out date and time based on the sales accomplishment of the same season in the last year.

According to this embodiment, the CPU 601 functions as the estimator 106.

The setter 101 sets the date and time prior to the sold-out date and time estimated by the estimator 106 as the offer deadline.

For example, the setter 101 sets the offer deadline in consideration of a time necessary for the second seller for delivery. For example, a time period (hereinafter, referred to as a “longest necessary delivery period”) until the commercial products arrive the warehouse is obtained when, for example, the commercial products are sent by the seller at the farthest address from the warehouse where the commercial products are stocked. Next, even if such a seller is selected as the second seller, it is estimated that the commercial product A of the first seller does not become out of stock before the commercial product A is delivered if several products are in stock. This stock quantity is obtained based on the longest necessary delivery period and the sales tendency of the commercial product A. That is, it is estimated that how many commercial products A will be sold during the longest necessary delivery period. The stock quantity is, for example, X(i−1), X(i), or X(i+1) in FIG. 15. When the stock quantity becomes X(i−1), X(i), or X(i+1), the acceptance of the offer is closed, and the selected second seller delivers during deliverable periods 825, 835. When the estimated sales tendency is the same as the actual sales of the commercial products, the deliverable period becomes equal to the longest necessary delivery period. Hence, when there is no great difference between the estimated sales tendency and the actual sales, it is possible for the second seller to deliver until the commercial product A of the first seller becomes sold out. Accordingly, it becomes possible to avoid a case in which there is no stock in the warehouse and the delivery to the user is delayed. In addition, since the offer deadline is set based on the sales tendency of the first seller, the offer deadline is unknown to the sales offerers, and thus it becomes possible to avoid a case in which the offer deadline is unknown to the sales offerers and the access to the selection device 100 becomes intensive.

Still further, the setter 101 may set, as the offer deadline, the date and time prior to the estimated sold-out date and time estimated by the estimator 106 by a predetermined grace period. For example, a period necessary until the commercial product becomes shippable after the second seller delivers the commercial product is obtained, and such a period is set as the grace period. When such a period is a day, the setter 101 sets the date and time one day before the estimated sold-out date and time as the offer deadline.

The acceptor 102 sets the least number of products based on the period until the product becomes sold out after the start of the sales thereof by the first seller and the number of products to be sold contained in the first sales condition, and the acceptor 102 does not accept an offer with the number of products to be sold in the sales condition smaller than the least number of products.

For example, it is possible to know how fast the commercial product A will be sold out in the collective sales configuration based on the period until the commercial product A becomes sold out (sold out 814) after the start of the sales thereof by an (i−1)-th seller (sales start 812), and the number of products to be sold that is “100 product units” in the first sales condition. When, for example, the period necessary for the second seller to deliver the commercial product as explained above is taken into consideration, the maximum number of products accomplished during the necessary time for delivery is set as the minimum number of products. When the minimum number of products is obtained in this manner, the acceptance of an offer after the commercial product A of the (i−1)-th seller becomes sold out is the time point that is an offer start 840, and thus the acceptance of an offer with the number of products to be sold smaller than the minimum number of products can be excluded among offers to select an (i+2)-th seller. The sales offerer can specify the desired number of products to be sold as long as it is equal to or greater than the minimum number of products.

To obtain the minimum number of products, the sold-out date and time estimated by the estimator 106 may be utilized instead of the period until the commercial product becomes sold out in practice. In this case, it is unnecessary to wait until the commercial product A of the (i−1)-th seller becomes sold out, and thus the acceptor 102 can exclude an offer with the number of products smaller than the minimum number of products among offers to select an (i+1)-th seller of which the acceptance starts (offer start 830) after the start of the sales of the commercial product A by the (i−1)-th seller.

In addition, the acceptor 102 may exclude an offer when the sale price and the information quantity of the introductory text specified in the offer do not satisfy predetermined criteria. In the collective sales configuration, when, for example, the manager would like to give a preference to the quality of the contents of the introductory text, it becomes possible to exclude an offer containing an introductory text not enriched. In addition, it may be determined whether an offer is accepted or excluded upon sorting offers based on whether or not the quality of the contents of the introductory text is important for each commercial product. For example, with respect to a generally well-known commercial product, it can be thought that the contents of the introductory text hardly affect the purchase by the user. Accordingly, when, for such a commercial product, an offer is made specifying the introductory text not enriched, such an offer may be accepted.

Alternatively, the acceptor 102 does not present the rough standard of the sales condition unlike FIG. 8, but may set the sale price, the number of products to be sold, or the information quantity of the introductory text desired at the shopping-server-200 end, and may accept only offers from the sellers who agree with such a condition.

When an acceptance of an offer that does not satisfy a predetermined condition is closed, the process load by the selector 103 can be reduced.

When the product for sale by the first seller under the first condition becomes sold out, with the second seller being as the new first seller, the obtainment by the obtainer 104, the estimation by the estimator 106, the setting by the setter 101, and the selection by the selector 103 are performed, the new second seller is selected, and such processes are repeated.

[6. Operation of Selection Device According to Second Embodiment]

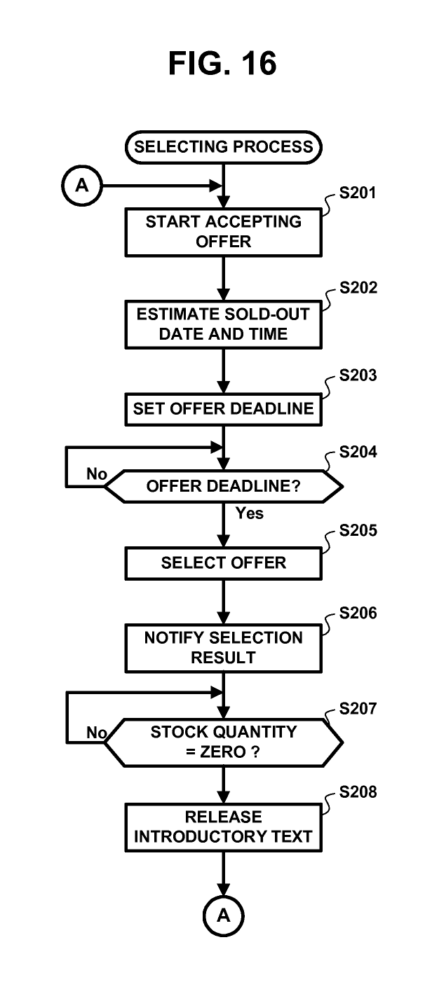

Next, an explanation will be given of an operation of the selection device 100 according to this embodiment with reference to the flowchart of FIG. 16. When the selection device 100 is powered on, the CPU 601 starts a selecting process illustrated in FIG. 16. In the flowchart of FIG. 16, the steps S204 to S208 have the same processes executed as those of the steps S103 to S107 in the flowchart of FIG. 13. Hence, the explanation thereof will be omitted.

The acceptor 102 accepts, from the seller who operates the seller terminal 300, an offer of a sales condition containing the number of products to be sold, the sale price, and the introductory text (step S201).

When, for example, it becomes the timing of the offer start 820 (see FIG. 15), the acceptor 102 accepts an offer from a person who desires sales as an i-th seller. In addition, the acceptor 102 excludes an offer that does not satisfy the predetermined criteria.

The estimator 106 estimates the sold-out date and time of the commercial product of the first seller (step S202).

For example, the sold-out date and time of the commercial product A of the (i−1)-th seller are estimated based on the sales tendency (the slope of the stock quantity after the sales start 812) during the predetermined period after the (i−1)-th seller starts selling the commercial product A (sales start 812).

The setter 101 sets the date and time prior to the sold-out date and time as the offer deadline (step S203).

For example, in consideration of a time necessary for the i-th seller that is the second seller to deliver the commercial product A, the setter 101 sets the offer deadline in such a way that the i-th seller ships the commercial product A after the offer deadline and can deliver the commercial product until the commercial product A of the (i−1)-th seller becomes sold out.

Next, after the processes in the steps S204 to S208 are executed, the process returns to the step S201, and the processes subsequent to the step S201 are repeated with the second seller being as the first seller and the second sales condition being as the first sales condition.

According to this embodiment, estimation of the sold-out date and time of the commercial product of the first seller enables an appropriate setting of the offer deadline. Hence, it becomes possible to suppress an out-of-stock condition of the commercial product.

The present invention is based on Japanese Patent Application No. 2011-184604 filed on Aug. 26, 2011. The whole specification, claims, and drawings of Japanese Patent Application No. 2011-184604 are herein incorporated in this specification by reference.

### INDUSTRIAL APPLICABILITY

According to the present invention, it becomes possible to provide a selection device, a selection method, a program, and a recording medium which are suitable for selecting one seller who sells a commercial product.

### REFERENCE SIGNS LIST

100 Selection device
101 Setter
102 Acceptor
103 Selector
104 Obtainer
105 Releaser
106 Estimator
200 Shopping server
301, 302 to 30m, 300 Seller terminal
401, 402 to 40n, 400 User terminal
500 Internet
600 Information processing device
602 ROM
603 RAM
604 NIC
605 Image processor
606 Sound processor
607 DVD-ROM drive
608 Interface
609 External memory
610 Controller
611 Monitor
612 Speaker
710 Introductory text
711 Image
712 Detailed explanation of product
720 Sale offer accepting page
721 Seller ID
722 Password
723 Login button
730 Sales condition entering page
731 Information
732, 733, 734, 735, 736 Field
737 Register button

1. A selection device comprising:
a setter that sets an offer deadline to apply for selling a product for sale by a first seller under a first sales condition after the first seller;
an acceptor that accepts an offer of a sales condition of the product containing at least a number of the products to be sold, a sale price and an introductory text from one or a plurality of sales offerers until the set offer deadline;
a selector that selects an offer among the offer from the one sales offerer or the offers from the plurality of sales offerers based on the sales condition of the accepted offer when the set offer deadline comes, sets the sales offerer with the selected offer as a second seller, and sets a sales condition of the selected offer as the second sales condition;
an obtainer that obtains a stock quantity of the product for sale by the first seller under the first sales condition; and
a releaser that releases an introductory text associated with the second sales condition in order to let the second seller start selling when the stock quantity fulfills a predetermined condition after the second seller is selected.

2. The selection device according to claim 1, further comprising an estimator that estimates, based on the obtained stock quantity, a sold-out date and time when the product for sale by the first seller under the first sales condition becomes sold out,
wherein the setter sets a date and time prior to the estimated sold-out date and time as the offer deadline.

3. The selection device according to claim 2, wherein the setter sets a date and time prior to the estimated sold-out date and time by a predetermined grace period as the offer deadline.

4. The selection device according to claim 3, wherein:
the acceptor sets a fewest number of products based on a period until the product becomes sold out after the start of the sales of the product by the first seller, and the number of products to be sold contained in the first sales condition; and
the acceptor excludes an offer with the sales condition containing the number of products to be sold that is less than the set fewest number of products.

5. The selection device according to claim 4, wherein when the product for sale by the first seller under the first sales condition becomes sold out, with the second seller being as a new first seller, an obtainment by the obtainer, an estimation by the estimator, a setting by the setter, and a selection by the selector are executed to repeatedly select a new second seller.

6. The selection device according to claim 1, wherein:
the selector selects an offer with a highest score obtained based on the sale price contained in the sales condition, the number of products to be sold contained in the sales condition, and an information quantity of the introductory text contained in the sales condition; and
the lower the sale price is, the greater the number of products to be sold is, and the greater the information quantity of the introductory text is, the higher the score is set.

7. The selection device according to claim 6, wherein the information quantity of the introductory text is defined based on a number of characters, a number of images, or a size of an image, contained in the introductory text.

8. The selection device according to claim 6, wherein the information quantity of the introductory text associated with an offer among the accepted offers is defined based on a number of words not appearing in the introductory texts associated with the other offers.

9. A selection method executed by a selection device comprising:
a setting step for setting an offer deadline to apply for selling a product for sale by a first seller under a first sales condition after the first seller;
an accepting step for accepting an offer of a sales condition of the product containing at least a number of the products to be sold, a sale price and an introductory text from one or a plurality of sales offerers until the set offer deadline;
a selecting step for selecting an offer among the offer from the one sales offerer or the offers from the plurality of sales offerers based on the sales condition of the accepted offer when the set offer deadline comes, settings the sales offerer with the selected offer as a second seller, and settings the sales condition of the selected offer as a second sales condition;
an obtaining step for obtaining a stock quantity of the product for sale by the first seller under the first sales condition; and
a releasing step for releasing an introductory text associated with the second sales condition in order to let the second seller start selling when the stock quantity fulfills a predetermined condition after the second seller is selected.

10. (canceled)

11. A computer-readable recording medium having stored therein a program that causes a computer to function as:
a setter that sets an offer deadline to apply for selling a product for sale by a first seller under a first sales condition after the first seller;
an acceptor that accepts an offer of a sales condition of the product containing at least a number of the products to be sold, a sale price and an introductory text from one or a plurality of sales offerers until the set offer deadline;
a selector that selects an offer among the offer from the one sales offerer or the offers from the plurality of sales offerers based on the sales condition of the accepted offer when the set offer deadline comes, sets the sales offerer with the selected offer as a second seller, and sets the sales condition of the selected offer as a second sales condition;
an obtainer that obtains a stock quantity of the product for sale by the first seller under the first sales condition; and
a releaser that releases an introductory text associated with the second sales condition in order to let the second seller start selling when the stock quantity fulfills a predetermined condition after the second seller is selected.
